(19) United States
(12) Patent Application Publication
(10) Pub. No.: US 2025/0066514 A1
(43) Pub. Date: Feb. 27, 2025

(54) CATALYSTS COMPONENT AND PROCESS FOR THE PRODUCTION OF POLYPROPYLENE HAVING HIGH MELT FLOW RATE WITH HIGH ISOTACTICITY

(71) Applicant: Formosa Plastics Corporation, U.S.A., Livingston, NJ (US)

(72) Inventors: Gapgoung Kong, Sugarland, TX (US); Gapgoung Kong, Sugarland, TX (US); Chih-Jian Chen, Port Lavaca, TX (US)

(21) Appl. No.: 18/455,236

(22) Filed: Aug. 24, 2023

(51) Int. Cl. C08F 4/76; C08F 110/06

(52) U.S. Cl. CPC C08F 4/76; C08F 110/06

(57) ABSTRACT

The present invention relates to a Ziegler-Natta catalyst composition for olefin polymerization, which comprises alkyltrialkoxysilane, urea, phthalate and 1,3-diether element as internal electron donors. The catalyst components, according to the present invention, are able to produce polypropylene polymers having high melt flow rate with high isotacticity.

### BACKGROUND

This invention relates to (1) Ziegler-Natta catalyst components for olefin polymerization prepared in the presence of alkyltrialkoxysilane, urea, phthalate and 1,3-diether as internal donor components and. (2) to methods of making such polymerization catalyst systems, which can produce polypropylene having high isotacticity and high melt flow rate.

Ziegler-Natta catalyst systems for polyolefin polymerization are well known in the art. Commonly, these systems are composed of a solid Ziegler-Natta catalyst component and a co-catalyst component, usually an organoaluminum compound, and/or an external electron donor to be used in conjunction. The Ziegler-Natta catalyst components have included magnesium, halide, titanium and internal electron donor compounds which have been widely employed to increase the activity and stero-specificity of polymerization catalyst system.

Common internal electron donor compounds, which are incorporated in the solid Ziegler-Natta catalyst component during preparation of such component, are known in the art and include ethers, ketones, amines, alcohols, heterocyclic organic compounds, phenols, phosphines, and silanes. It is well known in the art that polymerization activity, as well as stereoregularity, molecular weight, and molecular weight distribution of the resulting polymer depend on the molecular structure of the internal electron donor employed. Therefore, in order to improve the polymerization process and the properties of the resulting polymer, there has been an effort and desire to develop various internal electron donors. Examples of such internal electron donor compounds and their use as a component of the catalyst system are described in U.S. Pat. Nos. 4,107,414; 4,186,107; 4,226,963; 4,347,160; 4,382,019; 4,435,550; 4,465,782; 4,522,930; 4,530,912; 4,532,313; 4,560,671; 4,657,882; 5,208,302; 5,902,765; 5,948,872; 6,048,818; 6.121,483; 6,281.301; 6,294,497; 6,313,238; 6,395,670; 6,436,864; 6,605,562; 6,716,939; 6,770,586; 6,818,583; 6,825,309; 7,022,640; 7,049,377; 7,202,314; 7,208,435; 7,223,712; 7.351,778; 7.371,802; 7.491,781; 7,544,748; 7,674,741; 7,674,943; 7,888,437; 7,888,438; 7,935,766; 7,964,678; 8,003,558; 8,003,559; 8,088,872; 8,211,819; 8,222,357; 8,227,370; 8,236,908; 8,247.341; 8,263,520; 8,263,692; 8,288,304; 8,288,585; 8,288,606; 8,318,626; 8,383,540; 8,536,290; 8,569,195; 8,575,283; 8,604,146; 8,633,126; 8,692,927; 8,664,142; 8,680,222; 8,716,514; and 8,742,040, which are incorporated by reference herein in their entireties.

Meanwhile, there has been demand for polypropylene material having high stiffness and high melt flow rate. U.S. Pat. No. 7,465,776 introduced a catalyst component containing phthalate and diether internal donor producing polypropylene having high isotacticity and high melt flow rate. U.S. Pat. No. 5,652,303 and U.S. Pat. No. 6,087,459 describes a blend of two external donors of trialkoxysilane compounds and dicyclopentyldimethoxysilane in polymerization process to prepare broad MWD polypropylene. Also, U.S. Pat. No. 9,815,920 describes certain urea compounds employed as an internal donor component in combination with one or more internal electron donors to improve isotacticity for higher stiffness.

As such, there is still a need of development for a catalyst system that can produce polypropylene having high melt flow rate and high isotacticity with high activity.

### SUMMARY OF THE INVENTION

It is therefore an object of present invention to provide a method of preparing Ziegler-Natta catalyst components producing polypropylene having high melt flow rate and high isotacticity with higher activity, wherein the catalyst is prepared via contact reaction between magnesium, halide and titanium compound in the presence of alkyltrialkoxysilane, urea, phthalate and 1,3-diether as internal donor components.

According to present invention, alkyltrialkoxysilane selected from a compound represented by Formula I, and aurea compound selected from the compound represented by Formula II, are combined with phthalate and 1,3-diether to comprise internal donor components in a catalyst system. Formula I is as follows:

R—Si(OR¹)₃ [Formula I]

wherein R is aliphatic, vinyl, aromatic hydrocarbon group having 1 to 20 carbon atoms, and R¹ is an aliphatic hydrocarbon having 1 to 20 carbon atoms. Formula II is as follows:

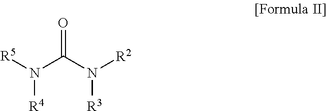

wherein R², R³, R⁴, and R⁵, which may be identical or different, are independently hydrogen, an aliphatic hydrocarbon group having 1 to 20 carbon atoms, an alicyclic hydrocarbon group having 3-20 carbon atoms, an aromatic hydrocarbon group having 6-20 carbon atoms, or a hetero atom containing a hydrocarbon group of 1 to 20 carbon atoms, wherein two or more of R², R³, R⁴, and R⁵ may be linked to form one or more saturated or unsaturated monocyclic or polycyclic rings.

### DESCRIPTION OF PREFERRED EMBODIMENTS

In accordance with certain embodiments of the present invention, urea and alkyltrialkoxysilane employed as an element of solid Ziegler-Natta catalyst components in conjunction with phthalate and 1,3-diether donors as internal donors, for the production of polyolefins, particularly polypropylene, are disclosed.

In a preferred embodiment of the present invention, the alkyltrialkoxysilane compounds that may be employed as an element of solid catalyst composition are represented by Formula I, and preferred examples of suitable alkyltrialkoxysilane of Formula I include, but are not limited to: methyltrimethoxysilane, ethyltrimethoxysilane, ethyltriethoxysilane, propyltriethoxysilane, propyltrimethoxysilane, propyltrimethoxysilane, butyltriethoxysilane, butyltrimethoxysilane, hexyltriethoxysilane, cyclohexyltriethoxysilane, pentyltriethoxysilane, cyclopentyltriethoxysilane, decyltriethoxysilane, vinyltriethoxysilane, and phenyltriethoxysilane.

The urea compounds that may be employed as an element of solid catalyst composition according to present invention, are represented by Formula II, and preferred examples of suitable urea compound of Formula II include, but are not limited to N,N,N′.N′-tetramethylurea; N,N,N′,N′-tctraethylurca; N,N,N′.N′-tetrapropylurea; N,N,N′,N′-tetrabutylurca; N,N,N′,N′-tetrapentylurea; N,N,N′, N′-tetrahexylurea; N,N,N′, N′-tetra(cyclopropyl)urea; N,N,N′,N′-tetra(cyclohexyl) urea; N,N,N′,N′-tetraphenylurea: bis(butylene)urea; bis(pentylene)urea; N,N′-dimethylethylencurca; N,N′-dimethylpropylencurca; N,N′-dimethyl(2-(methylaza)propylene)urea; N,N′-dimethyl (3-(methylaza)pentylene) urea; n-amyltriphenylurea, n-hexyltriphenylurea; n-octyltriphenylurca: n-decyltriphenylurca; n-octadecyltriphenylurea; n-butyltritolylurea; n-butyltrinaphthylurea; n-hexyltrimethylurea; n-hexyltriethylurea; noctyltrimethylurca; dihexyldimethylurea; dihexyldicthylurca: trihexylmethylurca: tetrahexylurea; n-butyltricyclohexylurea; t-butyltriphenylurea; 1,1-bis(p-biphenyl)-3-methyl-3-n-octadecylurea; 1.1-di-n-octadecyl-3-t-butyl-3-phenylurea: 1-p-biphenyl-1-methyl-3-noctadecyl 3 phenylurea: 1-methyl-1-n-octadecyl-3 p-biphenyl-3-o-tolylurea; m-terphenyl-tri-t-butylurea; 1,3-dimethyl-2-imidazolidinone; 1,3-diethyl-2-imidazolidinone; 1,3-dipropyl-2-imidazolidinone; 1,3-dibutyl-2-imidazolidinone; 1.3-dimethyl-3,4,5,6-tetrahydro-2-pyrimidinone; and N,N-dimethyl-N,N,-diphenylurea.

Alkyltrialkoxysilane can be employed as an element of Ziegler Natta catalyst with magnesium halide, titanium and internal donors in the ratio of about 0.01 to about 0.5 mol per mol of magnesium, preferably in the ratio of about 0.01 to about 0.1 mol per mol of magneisum. Urea compound can be employed as an element of Ziegler Natta catalyst with magnesium halide, titanium and internal donors in the ratio of about 0.01 to about 0.5 mol per mol of magnesium halide, preferably in the ratio of about 0.01-0.1.

According to certain aspects of the present invention, phthalate compounds that may be employed as an element of solid catalyst composition are ester forms of any phthalic acid compounds. Examples of phthalate can be used in conjunction with alkyltrialkoxysilane, urea compound and 1,3-diether include, but are not limited to: diethylphthalate, di-n-propylphthalate, di-n-butylphthalate, di-n-pentylphthalate, di-i-pentylphthalate, bis (2-ethylhexyl) phthalate, ethylisobutylphthalate, ethyl-n-butylphthalate, di-n-hexylphthalate, and di-isobutylphthalate.

According to present invention, 1,3 diether compounds are preferably selected from a compound represented by Formula (III):

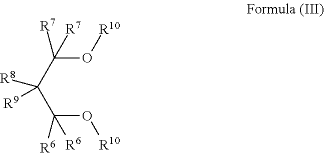

wherein R⁶ R⁷, R⁸, R⁹ and R10 are independently selected from a hydrocarbon group having 1 to 20 carbon atoms, an aromatic hydrocarbon group having 6-20 carbon atoms which can form one or more cyclic structure.

Preferred examples of 1,3-diethers that can be used according to the present invention include, but are not limited to: 2-(2-ethylhexyl) 1,3-dimethoxypropane, 2-isopropyl-1,3-dimethoxypropane, 2-butyl-1,3-dimethoxypropane, 2-sec-butyl-1,3-dimethoxypropane, 2-cyclohexyl-1,3-dimethoxypropane, 2-phenyl-1,3-dimethoxypropane, 2-tert-butyl-1,3-dimethoxypropane, 2-cumyl-1,3-dimethoxypropane, 2-(2-phenylethyl)-1,3-dimethoxypropane, 2,2-diethyl-1,3-diethoxypropane, 2,2-dicyclopentyl-1,3-dimethoxypropane, 2,2-dipropyl-1,3-diethoxypropane, 2,2-dibutyl-1,3-diethoxypropane, 2-methyl-2-ethyl-1,3-dimethoxypropane, 2-methyl-2-propyl-1,3-dimethoxypropane, 2-methyl-2-benzyl-1,3-dimethoxypropane, 2,2-diphenyl-1,3-dimethoxypropane, 2,2-dibenzyl-1,3-dimethoxypropane, 2-isopropyl-2-cyclopentyl-1,3-dimethoxypropane, 2,2-bis (cyclohexylmethyl)-1,3-dimethoxypropane, 2,2-diisobutyl-1,3-diethoxypropane, 2,2-diisobutyl-1,3-dibutoxypropane, 1,1-bis (methoxymethyl)-7-(3,3,3-trifluoropropyl) indene. 1,1-bis (methoxymethyl)-7-trimethyisilylindene; 1,1-bis (methoxymethyl)-7-trifluoromethylindenc. 1,1-bis (methoxymethyl)-4,7-dimethyl-4,5,6,7-tetrahydroindene. 1.1-bis (methoxymethyl)-7-methylinden, 1.1-bis (methoxymethyl)-1H-benz [e] indene, 1,1-bis (methoxymethyl)-1H-2-methylbenz [e] indene, 9,9-bis (methoxymethyl) fluorene, 9,9-bis (methoxymethyl)-2.3,6,7-tetramethylfluorene, 9,9-bis (methoxymethyl)-2,3,4,5,6,7-hexafluorofluorene, 9,9-bis (methoxymethyl)-2.3-benzofluorene, 9,9-bis (methoxymethyl)-2,3,6,7-dibenzofluorene, 9,9-bis (methoxymethyl)-2,7-diisopropylfluorene, 9,9-bis (methoxymethyl)-1,8-dichlorofluorene, 9,9-bis (methoxymethyl)-2,7-dicyclopentylfluorene, 9,9-bis (methoxymethyl)-1,8-difluorofluorene, 9,9-bis (methoxymethyl)-1,2,3,4-tetrahydrofluorene, 9,9-bis (methoxymethyl)-1,2,3,4,5,6,7,8-octahydrofluorene, and 9,9-bis (methoxymethyl)-4-tert-butylfluorene.

Acceptable anhydrous magnesium dihalides forming the support of the solid Ziegler-Natta type catalyst component (a) are the magnesium dihalides in active form that are well known in the art. Such magnesium dihalides may be preactivated, may be activated in situ during the titanation, may be formed in-situ from a magnesium compound which is capable of forming magnesium dihalide when treated with a suitable halogen-containing transition metal compound, and then activated. Preferred magnesium dihalides are magnesium dichloride and magnesium dibromide. The acceptable water content of the dihalides is generally less than 1% by weight.

The solid Ziegler-Natta type catalyst component (a) may be made by various methods. One such method consists of co-grinding the magnesium dihalide and the internal electron donor compound until the product shows a surface area higher than 20 m²/g and thereafter reacting the ground product with the Ti compound. Other methods of preparing solid Ziegler-Natta type catalyst component (a) are disclosed in U.S. Pat. Nos. 4,220,554; 4,294,721; 4,315,835; 4,330,649; 4,439,540; 4,816,433; and 4,978,648, which are incorporated herein by reference in their entireties.

In a typical modified solid Ziegler-Natta type catalyst component (a), the molar ratio between the magnesium dihalide and the halogenated titanium compound is between about 1 and 500, the molar ratio between said halogenated titanium compound and the internal electron donor is between about 0.1 and 50, and the molar ratio between said internal electron donor and the oxalic acid diamide modifier is between about 0.1 and 100.

Preferred co-catalyst component (b) includes aluminum alkyl compounds. Preferred aluminum alkyl compounds include aluminum trialkyls, such as aluminum triethyl, aluminum triisobutyl, and aluminum triisopropyl. Other acceptable aluminum alkyl compounds include aluminum-dialkyl hydrides, such as aluminum-diethyl hydrides. Other acceptable co-catalyst component (b) include compounds containing two or more aluminum atoms linked to each other through hetero-atoms, such as:

(C₂H₅)₂Al—O—Al(C₂H₅)₂

(C₂H₅)₂Al—N(C₆H₅)—Al(C₂H₅)₂; and

(C₂H₅)₂Al—O—SO₂—O—Al(C₂H₅)₂.

Acceptable external electron donor component (c) is organic compounds containing O, Si, N, S, and/or P. Such compounds include organic acids, organic acid esters, organic acid anhydrides, ethers, ketones, alcohols, aldehydes, silanes, amides, amines, amine oxides, thiols, various phosphorus acid esters and amides, etc. Preferred component (c) is organosilicon compounds containing Si—O—C and/or Si—N—C bonds. Preferred examples of such organosilicon compounds are trimethylmethoxysilane, diphenyldimethoxysilane, cyclohexylmethyldimethoxysilane, diisopropyldimethoxysilane, dicyclopentyldimethoxysilane, isobutyltriethoxysilane, vinyltrimethoxysilane, dicyclohexyldimethoxysilane, 3-tert-Butyl-2-isobutyl-2methoxy-[1,3,2] oxazasilolidine, 3-tert-Butyl-2-cyclopentyl-2-methoxy-[1,3,2] oxazasilolidine, 2-Bicyclo [2.2.1] hept-5-en-2-yl-3-tert-butyl-2-methoxy-[1,3,2] oxazasilolidine, 3-tert-Butyl-2,2-diethoxy-[1,3,2] oxazasilolidine, 4,9-Di-tert-butyl-1,6-dioxa-4,9-diaza-5-sila-spiro [4.4] nonane, and bis (perhydroisoquinolino) dimethoxysilane. Mixtures of organic electron donors may also be used in accordance with the present invention. Finally, the oxalic acid diamides of the present invention may also be employed as an external electronic donor.

The olefin polymerization processes that may be used in accordance with the present invention are not generally limited. For example, the catalyst components (a), (b) and (c), when employed, may be added to the polymerization reactor simultaneously or sequentially. It is preferred to mix components (b) and (c) first and then contact the resultant mixture with component (a) prior to the polymerization.

The olefin monomer may be added prior to, with, or after the addition of the Ziegler-Natta type catalyst system to the polymerization reactor. It is preferred to add the olefin monomer after the addition of the Ziegler-Natta type catalyst system. The molecular weight of the polymers may be controlled in a known manner, preferably by using hydrogen. With the catalysts produced according to the present invention, molecular weight may be suitably controlled with hydrogen when the polymerization is carried out at relatively low temperatures, e.g., from about 30°° C. to about 105° C. This control of molecular weight may be evidenced by a measurable positive change of the Melt Flow Rate.

The polymerization reactions may be carried out in slurry, liquid or gas phase processes, or in a combination of liquid and gas phase processes using separate reactors, all of which may be done either by batch or continuously. The polyolefin may be directly obtained from gas phase process, or obtained by isolation and recovery of solvent from the slurry process, according to conventionally known methods.

There are no particular restrictions on the polymerization conditions for production of polyolefins by the method of this invention, such as the polymerization temperature, polymerization time, polymerization pressure, monomer concentration, etc. The polymerization temperature is generally from 40-90° C. and the polymerization pressure is generally 1 atmosphere or higher.

The Ziegler-Natta type catalyst systems of the present invention may be pre-contacted with small quantities of olefin monomer, well known in the art as pre-polymerization, in a hydrocarbon solvent at a temperature of 60° C. or lower for a time sufficient to produce a quantity of polymer from 0.5 to 3 times the weight of the catalyst. If such a pre-polymerization is done in liquid or gaseous monomer, the quantity of resultant polymer is generally up to 1000 times the catalyst weight.

The Ziegler-Natta type catalyst systems of the present invention are useful in the polymerization of olefins, including but not limited to homo-polymerization and copolymerization of alpha olefins. Suitable a-olefins that may be used in a polymerization process in accordance with the present invention include olefins of the general formula CH₂═CHR, where Ris H or C₁₋₁₀ straight or branched alkyl, such as ethylene, propylene, butene-1, pentene-1, 4-methylpentene-1 and octene-1. While the Ziegler-Natta type catalyst systems of the present invention may be employed in processes in which ethylene is polymerized, it is more desirable to employ the Ziegler-Natta type catalyst systems of the present invention in processes in which polypropylene or higher olefins are polymerized. Processes involving the homopolymerization or copolymerization of propylene are preferred.

### EXAMPLES

In order to provide a better understanding of the foregoing, the following non-limiting examples are offered. Although the examples may be directed to specific embodiments, they are not to be viewed as limiting the invention in any specific respect. The activity values (AC) are based upon grams of polymer produced per gram of solid catalyst component used. The following analytical methods are used to characterize the polymer.

Heptane Insolubles (% HI): The weight percent (wt %) of residuals of polypropylene sample after extracted with boiling heptane for 8 hours. Melt Flow rate (MI): ASTM D-1238, determined at 230° C. under the load of 2.16 kg.

Tₘ: ASTM D-3417, determined by DSC (Manufacturer: TA Instrument, Inc; Model: DSC Q1000).

Determination of Isotactic Pentads Content: Place 400 mg of polymer sample into 10 mm NMR tube. 1.7 g TCE-d2 and 1.7 g o-DCB were added into the tube. ¹³C NMR spectra were acquired on a Bruker AVANCE 400 NMR (100.61 MHz, 90° pulse, 12 s delay between pulse). About 5000 transients were stored for each spectrum; mmmm pentad peak (21.09 ppm) was used as reference. The microstructure analysis was carried out as described in literature (Macromolecules, 1994, 27, 4521-4524, by V. Busico, et al.).

Molecular weight (Mn and Mw): The weight average molecular weight (Mw), number average molecular weight (Mn), and molecular weight distribution (Mw/Mn) of polymers were obtained by gel permeation chromatography on Water 2000GPCV system using Polymer Labs Plgel 10 um MIXED-B LS 300×7.5 mm columns and 1,2,4-trichlorobenzene (TCB) as mobile phase. The mobile phase was set at 0.9ml/min, and temperature was set at 145° C. Polymer samples were heated at 150° C. for two hours. Injection volume was 200 microliters. External standard calibration of polystyrene standards was used to calculate the molecular weight.

Magnesium ethoxide (98%), anhydrous toluene (99.8%), TiCl₄ (99.9%), anhydrous n-heptane (99%), diisobutyl phthalate (99%), cyclohexyl (dimethoxy) methylsilane (C-donor, ≥99%) and triethylaluminum (93%) were all purchased from Sigma-Aldrich Co. of Milwaukee, WI, USA.

Diisopropyldimethoxysilane (P-donor) and dicyclopentyldimethoxysilane (D-donor) were purchased from Gelest, Inc. of Morrisville, PA, USA.

Unless otherwise indicated, all reactions were conducted under an inert atmosphere.

### EXAMPLE 1

### (A) The Preparation of a Solid Catalyst Component

To a three-neck 250 ml flask equipped magnetic bar, which is thoroughly purged with anhydrous nitrogen, 7.5 g of magnesium ethoxide, and 70 ml of anhydrous toluene was introduced to form a suspension. 2.5 mmol of tetramethylurea. 3.0 mmol of propyltriethoxysilane, 5.0 mmol of diisobutylphthalate and 5.0 mmol of 2-isopentyl-2-isopropyl-dimethoxypropane were charged and then 20 ml of TiC14 was added. The temperature of the mixture was gradually raised to 110° C., and maintained for 2 hours with stirring. The resulting solid was precipitated and supernatant liquid was decanted. The solid was washed twice with 100 ml of anhydrous toluene at 90° C., and then 80 ml of fresh anhydrous toluene and 20 ml TiCl₄ was added to the filtered solid. Temperature of the mixture was heated to 110° C., and stirred for 2 hours. The solid was precipitated and supernatant liquid was decanted and residual solid was washed with heptane 7 times at 70° C. The final catalyst was collected and dried under vacuum to obtain a solid catalyst component (A1).

### (B) Propylene bulk phase polymerization

Propylene polymerization was conducted in a bench scale 2 liter reactor per the following procedure. The reactor was first preheated to at least 100° C. with a nitrogen purge to remove residual moisture and oxygen. The reactor was thereafter cooled to room temperature. Under nitrogen, 2.5 ml of triethylaluminum (0.6 M, in hexanes), 0.25 mmol of diisopropyldimethoxysilane and 8 mg of solid catalyst component (A1) prepared above were charged. After addition of hydrogen and 1.2 liter of liquefied propylene, temperature was raised to 70° C., to start polymerization. The polymerization was conducted for 1 hout at 70° C. The polymer was evaluated for melt flow rate (MFR), heptane insoluble (HI %). The activity of catalyst (AC) was also measured. The results are shown in TABLE 1 and TABLE 2.

### EXAMPLE 2

A solid catalyst component (A2) was prepared in the same manner as in Example 1, except that 6.0 mmol of propyltriethoxysilane was added. . . . The final catalyst was collected and dried under vacuum to obtain a solid catalyst component (A2). Propylene polymerization was carried out in the same manner as described in Example 1, except that solid catalyst component (A2) was charged instead of solid catalyst component (A1). The results are summarized in TABLE 1 & 2.

### EXAMPLE 3

A solid catalyst component (A3) was prepared in the same manner as in Example 1, except that 3.0 mmol of vinyltriethoxysilane was added instead of 3.0 mmol of propyltriethoxysilane. The final catalyst was collected and dried under vacuum to obtain a solid catalyst component (A3). Propylene polymerization was carried out in the same manner as described in Example 1, except that solid catalyst component (A3) was charged instead of solid catalyst component (A3). The results are summarized in TABLE 1 and TABLE 2.

### Comparative Example 1

A solid catalyst component (C1) was prepared in the same manner as in Example 1, except that propyltriethoxysilane and tetramethylurea were not added. . . . The final catalyst was collected and dried under vacuum to obtain a solid catalyst component (C1). Propylene polymerization was carried out in the same manner as described in Example 1, except that solid catalyst component (A3) was charged instead of solid catalyst component (C1). The results are summarized in TABLE 1 & 2.

TABLE 1
Urea and alkyltrialkoxysilane & internal donor
composition in solid Catalyst Components

| Catalyst | | Alkyltrialkoxysilane | Internal donors |
|---|---|---|---|
| components | Urea added | added | added (mmol) |
| Catalyst A1 | 2.5 mmol | 3.0 mmol | diisobutylphthalate (5.0) |
| | tetramethylurea | propyltriethoxysilane | 2-isopenty1-2-isopropyl- |
| | | | dimethoxypropane (5.0) |
| Catalyst A2 | 2.5 mmol | 6.0 mmol | diisobutylphthalate (5.0) |
| | tetramethylurea | propyltriethoxysilane | 2-isopenty1-2-isopropyl- |
| | | | dimethoxypropane (5.0) |
| Catalyst A3 | 2.5 mmol | 3.0 mmol | diisobutylphthalate (5.0) |
| | tetramethylurea | vinyltriethoxysilane | 2-isopentyl-2-isopropyl- |
| | | | dimethoxypropane (5.0) |
| Catalyst C1 | No | No | diisobutylphthalate (5.0) |
| | | | 2-isopenty1-2-isopropyl- |
| | | | dimethoxypropane (5.0) |

TABLE 2
Polymerization Summary

| | | Ext. | | | | |
|---|---|---|---|---|---|---|
| | Catalyst | Donor | H2 | MFR | Yield | |
| Example | Component | (mmol) | (psi) | (g/10 min) | (g) | Hi %* |
| Ex. 1 | A1 | P (0.4) | 30 | 8.6 | 294.6 | 99.18 |
| | | | 40 | 32.3 | 273.7 | 98.93 |
| | | | 60 | 93.5 | 296.4 | 98.65 |
| | | | 80 | 198.3 | 260.3 | 98.15 |
| Ex 2 | A2 | P (0.4) | 30 | 14.9 | 260.5 | 99.13 |
| | | | 40 | 16.5 | 298.1 | 99.07 |
| | | | 60 | 90.3 | 237.1 | 98.93 |
| | | | 80 | 221.7 | 289.8 | 98.06 |
| Ex 3 | A3 | P (0.4) | 30 | 7.65 | 314.0 | 99.08 |
| | | | 40 | 33.0 | 330.0 | 98.90 |
| Com Ex 1 | C1 | P (0.4) | 20 | 4.3 | 199.3 | 98.98 |
| | | | 30 | 14.3 | 298.3 | 98.66 |
| | | | 40 | 39.0 | 270.1 | 98.24 |

As shown from the above results, the catalyst components (A1), (A2) and (A3) according to present invention employing tetramethylurea and propyltriethoxysilane compounds in combination with diisobutylphthalate and 1,3-diether as internal donors, produce polypropylene with much higher isotacticity than that of comparative catalyst components (C1) that does not contain tetramethylurea and propyltriethoxysilane in its solid catalyst composition. Also, (A1), (A2), and (A3) according to present invention produce high melt flow rate polymer of MFR=32.3˜221.7, with high isotacticity of HI % =98.06 ˜ 99.13%.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Whenever a numerical range with a lower limit and an upper limit is disclosed, any number falling within the range is specifically disclosed. Moreover, the indefinite articles “a” or “an”, as used in the claims, are defined herein to mean one or more than one of the element that it introduces.

What is claimed is:

1. A solid catalyst component for the polymerization or co-polymerization of alpha-olefin comprising: titanium, magnesium, halogen, an alkyltrialkoxysilane compound, a urea compound, a phthalate compound, and a 1,3-diether compound as internal donor components;
wherein the alkyltrialkoxysilane compound is selected from the compound represented by Formula I,
R—Si(OR¹)₃ [Formula I]
wherein R is an aliphatic, vinyl, or aromatic hydrocarbon group having 1 to 20 carbon atoms, and wherein R¹ is an aliphatic hydrocarbon having 1 to 20 carbon atoms;
wherein the urea compound is selected from the compound represented by Formula II: 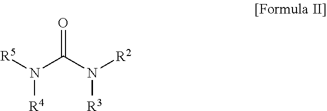
wherein R², R³, R⁴, and R⁵, which may be identical or different, are independently selected from hydrogen, an aliphatic hydrocarbon group having 1 to 20 carbon atoms, an alicyclic hydrocarbon group having 3-20 carbon atoms, an aromatic hydrocarbon group having 6-20 carbon atoms, or a heteroatom containing a hydrocarbon group of 1 to 20 carbon atoms, wherein two or more of R², R³, R⁴, and R⁵ may be linked to form one or more saturated or unsaturated monocyclic or polycyclic rings.

2. The solid catalyst component of claim 1, wherein the alkyltrialkoxysilane compound is selected from methyltrimethoxysilane, ethyltrimethoxysilane, ethyltriethoxysilane, propyltriethoxysilane, propyltrimethoxysilane, propyltrimethoxysilane, butyltriethoxysilane, butyltrimethoxysilane, hexyltriethoxysilane, cyclohexyltriethoxysilane, pentyltriethoxysilane, cyclopentyltriethoxysilane, decyltriethoxysilane, and combinations thereof.

3. The solid catalyst component of claim 1, wherein the alkyltrialkoxysilane compound comprises propyltriethoxysilane.

4. The solid catalyst component of claim 1, wherein the urea compound is selected from N.N,N′,N′-tetramethylurea, N,N,N′,N′-tetraethylurea, N,N,N′.N′-tetrapropylurea, N,N,N′.N′-tetrabutylurea, N,N,N′,N′-tetrapentylurea, N,N,N′,N′-tetrahexylurea, N.N,N′,N′-tetra (cyclopropyl) urea. N,N,N′,N′-tetra (cyclohexyl) urea, N,N,N′.N′-tetraphenylurea, bis (butylene) urea, bis (pentylene) urea, N,N′-dimethylethyleneurea, N,N′-dimethylpropyleneurea, dipropyl-2-imidazolidinone, 1,3-dibutyl-2-imidazolidinone, 1,3-dimethyl-3,4,5,6-tetrahydro-2-pyrimidinone, N,N-dimethyl-N,N,-diphenylurea, and combinations thereof.

5. The solid catalyst component of claim 1, wherein the urea compound comprises tetramethylurea.

6. The solid catalyst component of claim 1, wherein the phthalate compound is selected from diethylphthalate, di-n-propylphthalate, di-n-butylphthalate, di-n-pentylphthalate, di-i-pentylphthalate, bis (2-ethylhexyl) phthalate, ethylisobutylphthalate, ethyl-n-butylphthalate, di-n-hexylphthalate, di-isobutylphthalate, and combinations thereof.

7. The solid catalyst component of claim 1, wherein the phthalate compound comprises diisobutylphthalate.

8. The solid catalyst component of claim 1, wherein 1,3 diether compound is selected from compound represented by Formula (III): 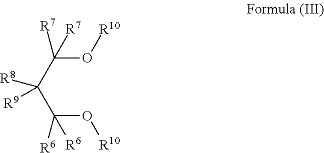
wherein R⁶ R⁷, R⁸, and R¹⁰ are independently selected from a hydrocarbon group having 1 to 20 carbon atoms, or an aromatic hydrocarbon group having 6-20 carbon atoms, which can form one or more cyclic structure.

9. The solid catalyst component of claim 1, wherein 1.3 diether compound comprises 2-isopentyl-2-isopropyl-dimethoxypropane.
